(19) United States
(12) Patent Application Publication
(10) Pub. No.: US 2014/0134655 A1
(43) Pub. Date: May 15, 2014

(54) SYSTEM AND METHOD FOR DETECTION OF SAMPLE VOLUME DURING INITIAL SAMPLE FILL OF A BIOSENSOR TO DETERMINE GLUCOSE CONCENTRATION IN FLUID SAMPLES OR SAMPLE FILL ERROR

(71) Applicant: CILAG GMBH INTERNATIONAL, Zug (CH)

(72) Inventor: David ELDER, Inverness (GB)

(73) Assignee: Cilag GmbH International, Zug (CH)

(21) Appl. No.: 13/673,119

(22) Filed: Nov. 9, 2012

(51) Int. Cl. G06F 19/10

(52) U.S. Cl. CPC G06F 19/10
USPC 435/14; 435/287.1

(57) ABSTRACT

Described are methods and systems to allow for a determination of when a sample has substantially stopped filling a test chamber so that a test sequence timer can be initiated at the appropriate time point for assaying of a biosensor. This determination can also be used to evaluate whether the biosensor has been filled with additional fluid samples after an initial fill of the biosensor. These methods and systems allow for a more accurate analyte test result.

### BACKGROUND

Analyte detection in physiological fluids, e.g. blood or blood derived products, is of ever increasing importance to today's society. Analyte detection assays find use in a variety of applications, including clinical laboratory testing, home testing, etc., where the results of such testing play a prominent role in diagnosis and management in a variety of disease conditions. Analytes of interest include glucose for diabetes management, cholesterol, and the like. In response to this growing importance of analyte detection, a variety of analyte detection protocols and devices for both clinical and home use have been developed.

One type of method that is employed for analyte detection is an electrochemical method. In such methods, an aqueous liquid sample is placed into a sample-receiving chamber in an electrochemical cell that includes two electrodes, e.g., a counter and working electrode. The analyte is allowed to react with a redox reagent to form an oxidizable (or reducible) substance in an amount corresponding to the analyte concentration. The quantity of the oxidizable (or reducible) substance present is then estimated electrochemically and related to the amount of analyte present in the initial sample.

Such systems are susceptible to various modes of inefficiency or error.

### SUMMARY OF THE DISCLOSURE

Applicant has recognized that a referential start time in which a specific sequence of output current measurements made as a function of precise intervals from the referential start time may not be optimal if a time point when a fluid sample has stopped flowing into a test chamber of a biosensor cannot be precisely determined. Hence, applicant has discovered heretofore novel techniques to allow for a determination of when to start a test measurement sequence based on a determination of when sample has substantially stopped flowing into a test chamber of a biosensor.

In one aspect, a method of determining an analyte concentration from a fluid sample with a test strip and an analyte monitor is provided. The analyte monitor has a microprocessor coupled to a test strip port and adapted to receive corresponding connectors connected to at least two electrodes of the test strip. The method can be achieved by: depositing a fluid sample onto the at least two electrodes; measuring a capacitance of the fluid sample with the at least two electrodes; evaluating whether the measured capacitance from the measuring step is above a first threshold; in the event the measured capacitance is not above the first threshold, repeating the measuring step again otherwise if the measured capacitance is above the first threshold, ascertaining a capacitance of the fluid sample; evaluating whether the ascertained capacitance from the ascertaining step is substantially the same or less than a previous measurement of the capacitance; in the event the ascertained capacitance is not less than previous measurement of capacitance, performing the ascertaining again otherwise if the ascertained capacitance is substantially the same or less than a previous measurement of the capacitance of the sample then storing the ascertained capacitance as a first capacitance value and setting a test sequence time clock to zero immediately after the storing step to define a start time of an analyte measurement test sequence interval; applying a series of electrical potentials to the at least two electrodes during the measurement sequence interval starting from a zero time point of the test sequence time clock; sampling a current output transient from the at least two electrodes during the measurement test sequence interval to obtain a series of current output transients; and calculating an analyte concentration from the series of current output transients of the sampling step.

In another aspect, a method of determining an analyte concentration from a fluid sample with a test strip and an analyte monitor is provided. The analyte monitor has a microprocessor coupled to a test strip port and adapted to receive corresponding connectors connected to at least two electrodes of the test strip. The method can be achieved by: depositing a fluid sample onto the at least two electrodes; measuring a capacitance of the fluid sample with the at least two electrodes; evaluating whether the measured capacitance from the measuring step is above a first threshold; in the event the measured capacitance is not above the first threshold, repeating the measuring step again otherwise if the measured capacitance is above the first threshold, ascertaining a capacitance of the fluid sample; evaluating whether the ascertained capacitance from the ascertaining step is substantially the same or less than a previous measurement of the capacitance; in the event the ascertained capacitance is not less than previous measurement of capacitance, performing the ascertaining again otherwise if the ascertained capacitance is substantially the same or less than a previous measurement of the capacitance of the sample then storing the ascertained capacitance as a first capacitance value and setting a test sequence time clock to zero immediately after the storing step to define a start time of an analyte measurement test sequence interval; applying a series of electrical potentials to the at least two electrodes during the measurement sequence interval starting from a zero time point of the test sequence time clock; measuring a capacitance during the test sequence interval after the setting of the time clock to zero; storing the measured capacitance during the test sequence interval as a second capacitance; evaluating whether the second capacitance is greater in magnitude than the first capacitance; in the event the evaluating indicates that the second capacitance is greater than the first capacitance, annunciating an error due to additional fluid samples being added after the start of the test sequence time clock.

In a further aspect, a method of determining an analyte concentration from a fluid sample with a test strip and an analyte monitor is provided. The analyte monitor has a microprocessor coupled to a test strip port and adapted to receive corresponding connectors connected to at least two electrodes of the test strip. The method can be achieved by: depositing a fluid sample onto the at least two electrodes; measuring a capacitance of the fluid sample with the at least two electrodes; evaluating whether the measured capacitance from the measuring step is above a first threshold; in the event the measured capacitance is not above the first threshold, repeating the measuring step again otherwise if the measured capacitance is above the first threshold, ascertaining a capacitance of the fluid sample; evaluating whether the ascertained capacitance from the ascertaining step is substantially the same or less than a previous measurement of the capacitance; in the event the ascertained capacitance is not less than previous measurement of capacitance, performing the ascertaining again otherwise if the ascertained capacitance is substantially the same or less than a previous measurement of the capacitance of the sample then storing the ascertained capacitance as a first capacitance value and setting a test sequence time clock to zero immediately after the storing step to define a start time of an analyte measurement test sequence interval.

In yet a further aspect, an analyte measurement system is provided that includes at least one analyte test strip and an analyte meter. The at least one analyte strip includes a substrate having a reagent disposed thereon and at least two electrodes proximate the reagent in test chamber. The analyte meter includes a strip port connector disposed to connect to the two electrodes, a power supply; and a microcontroller. The microcontroller is electrically coupled to the strip port connector and the power supply so that, when the test strip is inserted into the strip port connector and a fluid sample is deposited in the test chamber, the microcontroller determines when the fluid sample has stopped filling the test chamber to define a start time of an analyte test sequence.

In each of the above aspects, each of the following features can be utilized with each of the above aspects or in combination with each other. The features may include, for example, applying an alternating signal at a predetermined frequency to the at least two electrodes and measuring a phase signal from the at least two electrodes; a first threshold of about 10 nanofarads for the capacitance measurement; and the analyte may be glucose.

These and other embodiments, features and advantages will become apparent to those skilled in the art when taken with reference to the following more detailed description of various exemplary embodiments of the invention in conjunction with the accompanying drawings that are first briefly described.

### BRIEF DESCRIPTION OF THE DRAWINGS

The accompanying drawings, which are incorporated herein and constitute part of this specification, illustrate presently preferred embodiments of the invention, and, together with the general description given above and the detailed description given below, serve to explain features of the invention (wherein like numerals represent like elements).

FIG. 1A illustrates a preferred blood glucose measurement system.

FIG. 1B illustrates the various components disposed in the meter of FIG. 1A.

FIG. 1C illustrates a perspective view of an assembled test strip suitable for use in the system and methods disclosed herein;

FIG. 1D illustrates an exploded perspective view of an unassembled test strip suitable for use in the system and methods disclosed herein;

FIG. 1E illustrates an expanded perspective view of a proximal portion of the test strip suitable for use in the system and methods disclosed herein;

FIG. 2 is a bottom plan view of one embodiment of a test strip disclosed herein;

FIG. 3 is a side plan view of the test strip of FIG. 2;

FIG. 4A is a top plan view of the test strip of FIG. 3;

FIG. 4B is a partial side view of a proximal portion of the test strip of FIG. 4A;

FIG. 5 is a simplified schematic showing a test meter electrically interfacing with portions of a test strip disclosed herein;

FIG. 6A shows an example of a tri-pulse potential waveform applied by the test meter of FIG. 5 to the working and counter electrodes for prescribed time intervals;

FIG. 6B shows a current transient CT generated by a physiological sample;

FIG. 7A illustrates an initial sample fill detection in order to set the initiation time as a referential datum for the various time intervals in FIG. 6A;

FIG. 7B illustrates a capacitance model of the biosensor on which capacitance can be measured for the initial fill detection and volume detection;

FIG. 7C illustrates an electronic circuit representative of the biosensor model of FIG. 7B;

FIG. 7D illustrates the relationship between fill time, fill rate of change over time, fill level, capacitance as a function of the fill level and capacitance over time.

FIG. 8A illustrates a first technique to determine when the initial fill of the biosensor with a sample volume has been achieved; and

FIG. 8B illustrates a second technique in which the initial fill of the biosensor is compared with a volume sufficiency detection to determine if the biosensor has been reapplied with additional samples.

### MODES FOR CARRYING OUT THE INVENTION

The following detailed description should be read with reference to the drawings, in which like elements in different drawings are identically numbered. The drawings, which are not necessarily to scale, depict selected embodiments and are not intended to limit the scope of the invention. The detailed description illustrates by way of example, not by way of limitation, the principles of the invention. This description will clearly enable one skilled in the art to make and use the invention, and describes several embodiments, adaptations, variations, alternatives and uses of the invention, including what is presently believed to be the best mode of carrying out the invention.

As used herein, the terms “about” or “approximately” for any numerical values or ranges indicate a suitable dimensional tolerance that allows the part or collection of components to function for its intended purpose as described herein. In addition, as used herein, the terms “patient,” “host,” “user,” and “subject” refer to any human or animal subject and are not intended to limit the systems or methods to human use, although use of the subject invention in a human patient represents a preferred embodiment.

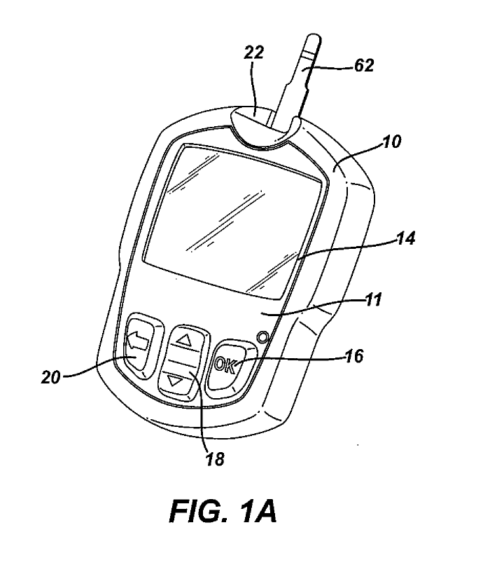

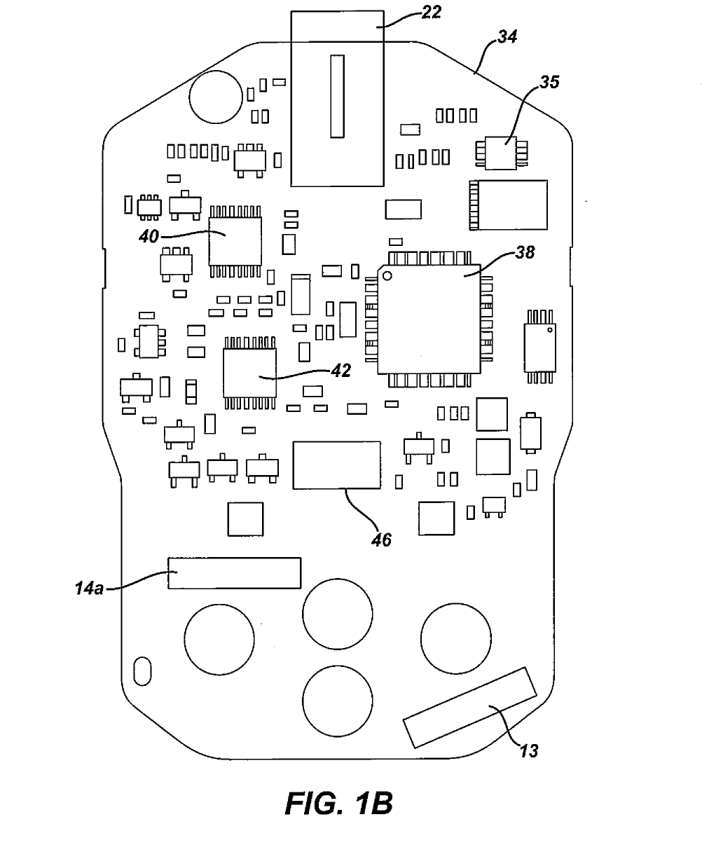

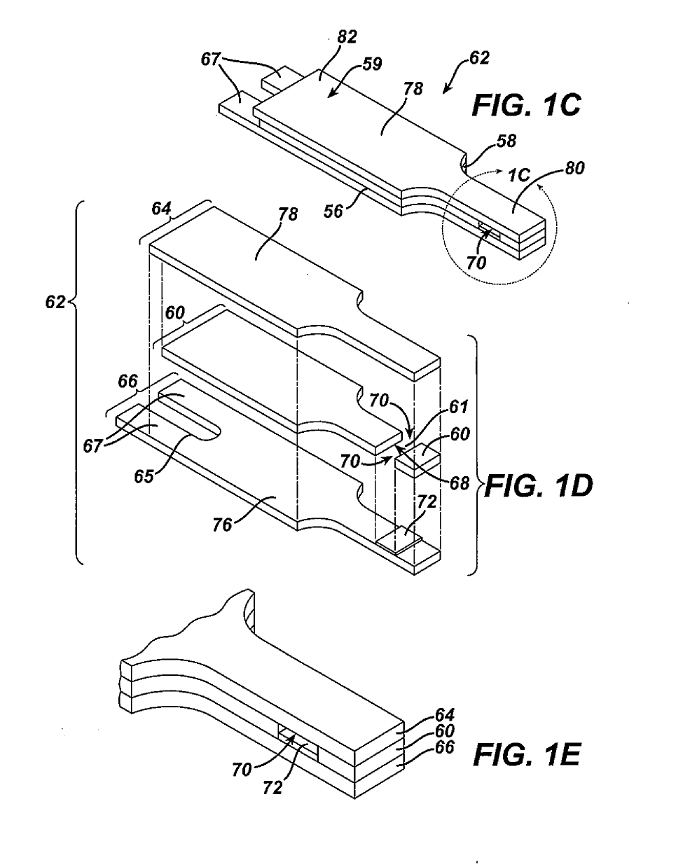

FIG. 1A illustrates a diabetes management system that includes a meter 10 and a biosensor in the form of a glucose test strip 62. Note that the meter (meter unit) may be referred to as an analyte measurement and management unit, a glucose meter, a meter, and an analyte measurement device. In an embodiment, the meter unit may be combined with an insulin delivery device, an additional analyte testing device, and a drug delivery device. The meter unit may be connected to a remote computer or remote server via a cable or a suitable wireless technology such as, for example, GSM, CDMA, BlueTooth, WiFi and the like.

Referring back to FIG. 1A, glucose meter or meter unit 10 may include a housing 11, user interface buttons (16, 18, and 20), a display 14, and a strip port opening 22. User interface buttons (16, 18, and 20) may be configured to allow the entry of data, navigation of menus, and execution of commands. User interface button 18 may be in the form of a two way toggle switch. Data may include values representative of analyte concentration, or information, which are related to the everyday lifestyle of an individual. Information, which is related to the everyday lifestyle, may include food intake, medication use, occurrence of health check-ups, and general health condition and exercise levels of an individual. The electronic components of meter 10 may be disposed on a circuit board 34 that is within housing 11.

FIG. 1B illustrates (in simplified schematic form) the electronic components disposed on a top surface of circuit board 34. On the top surface, the electronic components include a strip port connector 22, an operational amplifier circuit 35, a microcontroller 38, a display connector 14a, a non-volatile memory 40, a clock 42, and a first wireless module 46. On the bottom surface, the electronic components may include a battery connector (not shown) and a data port 13. Microcontroller 38 may be electrically connected to strip port connector 22, operational amplifier circuit 35, first wireless module 46, display 14, non-volatile memory 40, clock 42, battery, data port 13, and user interface buttons (16, 18, and 20).

Operational amplifier circuit 35 may include two or more operational amplifiers configured to provide a portion of the potentiostat function and the current measurement function. The potentiostat function may refer to the application of a test voltage between at least two electrodes of a test strip. The current function may refer to the measurement of a test current resulting from the applied test voltage. The current measurement may be performed with a current-to-voltage converter. Microcontroller 38 may be in the form of a mixed signal microprocessor (MSP) such as, for example, the Texas Instrument MSP 430. The TI-MSP 430 may be configured to also perform a portion of the potentiostat function and the current measurement function. In addition, the MSP 430 may also include volatile and non-volatile memory. In another embodiment, many of the electronic components may be integrated with the microcontroller in the form of an application specific integrated circuit (ASIC).

Strip port connector 22 may be configured to form an electrical connection to the test strip. Display connector 14a may be configured to attach to display 14. Display 14 may be in the form of a liquid crystal display for reporting measured glucose levels, and for facilitating entry of lifestyle related information. Display 14 may optionally include a backlight. Data port 13 may accept a suitable connector attached to a connecting lead, thereby allowing glucose meter 10 to be linked to an external device such as a personal computer. Data port 13 may be any port that allows for transmission of data such as, for example, a serial, USB, or a parallel port. Clock 42 may be configured to keep current time related to the geographic region in which the user is located and also for measuring time. The meter unit may be configured to be electrically connected to a power supply such as, for example, a battery.

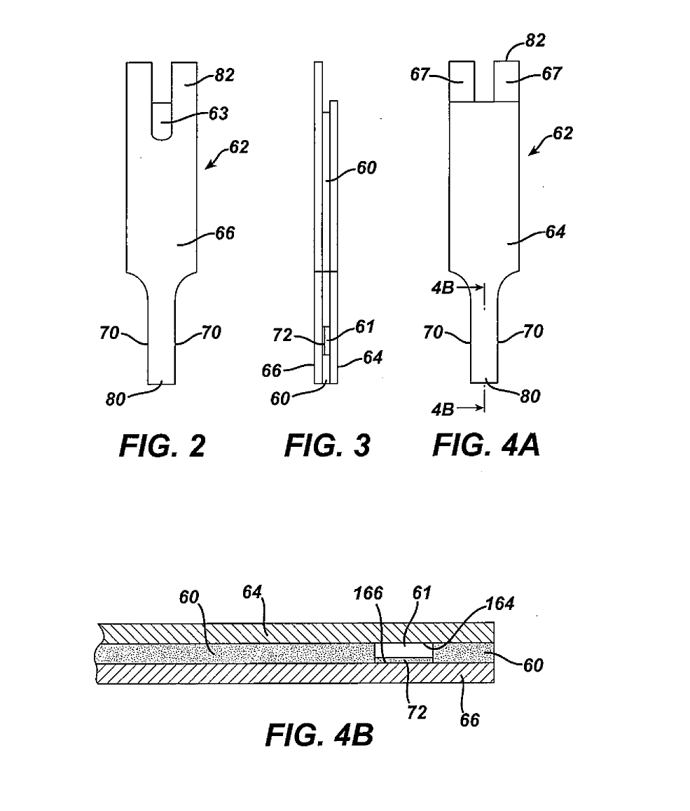

FIGS. 1C-1E, 2, 3, and 4B show various views of an exemplary test strip 62 suitable for use with the methods and systems described herein. In an exemplary embodiment, a test strip 62 is provided which includes an elongate body extending from a distal end 80 to a proximal end 82, and having lateral edges 56, 58, as illustrated in FIG. 1C. As shown in FIG. 1D, the test strip 62 also includes a first electrode layer 66, a second electrode layer 64, and a spacer 60 sandwiched in between the two electrode layers 64 and 66. The first electrode layer 66 may include a first electrode 66, a first connection track 76, and a first contact pad 67, where the first connection track 76 electrically connects the first electrode 66 to the first contact pad 67, as shown in FIGS. 1D and 4B. Note that the first electrode 66 is a portion of the first electrode layer 66 that is immediately underneath the reagent layer 72, as indicated by FIGS. 1D and 4B. Similarly, the second electrode layer 64 may include a second electrode 64, a second connection track 78, and a second contact pad 63, where the second connection track 78 electrically connects the second electrode 64 with the second contact pad 63, as shown in FIGS. 1D, 2, and 4B. Note that the second electrode 64 is a portion of the second electrode layer 64 that is above the reagent layer 72, as indicated by FIG. 4B.

As shown, the sample-receiving chamber 61 is defined by the first electrode 66, the second electrode 64, and the spacer 60 near the distal end 80 of the test strip 62, as shown in FIGS. 1D and 4B. The first electrode 66 and the second electrode 64 may define the bottom and the top of sample-receiving chamber 61, respectively, as illustrated in FIG. 4B. A cutout area 68 of the spacer 60 may define the sidewalls of the sample-receiving chamber 61, as illustrated in FIG. 4B. In one aspect, the sample-receiving chamber 61 may include ports 70 that provide a sample inlet or a vent, as shown in FIGS. 1C to 1E. For example, one of the ports may allow a fluid sample to ingress and the other port may allow air to egress.

In an exemplary embodiment, the sample-receiving chamber 61 (or test cell or test chamber) may have a small volume. For example, the chamber 61 may have a volume in the range of from about 0.1 microliters to about 5 microliters, about 0.2 microliters to about 3 microliters, or, preferably, about 0.3 microliters to about 1 microliter. To provide the small sample volume, the cutout 68 may have an area ranging from about 0.01 cm² to about 0.2 cm², about 0.02 cm² to about 0.15 cm², or, preferably, about 0.03 cm² to about 0.08 cm². In addition, first electrode 66 and second electrode 64 may be spaced apart in the range of about 1 micron to about 500 microns, preferably between about 10 microns and about 400 microns, and more preferably between about 40 microns and about 200 microns. The relatively close spacing of the electrodes may also allow redox cycling to occur, where oxidized mediator generated at first electrode 66, may diffuse to second electrode 64 to become reduced, and subsequently diffuse back to first electrode 66 to become oxidized again. Those skilled in the art will appreciate that various such volumes, areas, or spacing of electrodes is within the spirit and scope of the present disclosure.

In one embodiment, the first electrode layer 66 and the second electrode layer 64 may be a conductive material formed from materials such as gold, palladium, carbon, silver, platinum, tin oxide, iridium, indium, or combinations thereof (e.g., indium doped tin oxide). In addition, the electrodes may be formed by disposing a conductive material onto an insulating sheet (not shown) by a sputtering, electroless plating, or a screen-printing process. In one exemplary embodiment, the first electrode layer 66 and the second electrode layer 64 may be made from sputtered palladium and sputtered gold, respectively. Suitable materials that may be employed as spacer 60 include a variety of insulating materials, such as, for example, plastics (e.g., PET, PETG, polyimide, polycarbonate, polystyrene), silicon, ceramic, glass, adhesives, and combinations thereof. In one embodiment, the spacer 60 may be in the form of a double sided adhesive coated on opposing sides of a polyester sheet where the adhesive may be pressure sensitive or heat activated. Applicants note that various other materials for the first electrode layer 66, the second electrode layer 64, or the spacer 60 are within the spirit and scope of the present disclosure.

Either the first electrode 66 or the second electrode 64 may perform the function of a working electrode depending on the magnitude or polarity of the applied test voltage. The working electrode may measure a limiting test current that is proportional to the reduced mediator concentration. For example, if the current limiting species is a reduced mediator (e.g., ferrocyanide), then it may be oxidized at the first electrode 66 as long as the test voltage is sufficiently greater than the redox mediator potential with respect to the second electrode 64. In such a situation, the first electrode 66 performs the function of the working electrode and the second electrode 64 performs the function of a counter/reference electrode. Applicants note that one may refer to a counter/reference electrode simply as a reference electrode or a counter electrode. A limiting oxidation occurs when all reduced mediator has been depleted at the working electrode surface such that the measured oxidation current is proportional to the flux of reduced mediator diffusing from the bulk solution towards the working electrode surface. The term “bulk solution” refers to a portion of the solution sufficiently far away from the working electrode where the reduced mediator is not located within a depletion zone. It should be noted that unless otherwise stated for test strip 62, all potentials applied by test meter 10 will hereinafter be stated with respect to second electrode 64.

Similarly, if the test voltage is sufficiently less than the redox mediator potential, then the reduced mediator may be oxidized at the second electrode 64 as a limiting current. In such a situation, the second electrode 64 performs the function of the working electrode and the first electrode 66 performs the function of the counter/reference electrode.

Initially, an analysis may include introducing a quantity of a fluid sample into a sample-receiving chamber 61 via a port 70. In one aspect, the port 70 or the sample-receiving chamber 61 may be configured such that capillary action causes the fluid sample to fill the sample-receiving chamber 61. The first electrode 66 or second electrode 64 may be coated with a hydrophilic reagent to promote the capillarity of the sample-receiving chamber 61. For example, thiol derivatized reagents having a hydrophilic moiety such as 2-mercaptoethane sulfonic acid may be coated onto the first electrode or the second electrode.

In the analysis of strip 62 above, reagent layer 72 can include glucose dehydrogenase (GDH) based on the PQQ co-factor and ferricyanide. In another embodiment, the enzyme GDH based on the PQQ co-factor may be replaced with the enzyme GDH based on the FAD co-factor. When blood or control solution is dosed into a sample reaction chamber 61, glucose is oxidized by GDH₍ₒₓ₎ and in the process converts GDH₍ₒₓ₎ to GDH_{(red)}, as shown in the chemical transformation T.1 below. Note that GDH₍ₒₓ₎ refers to the oxidized state of GDH, and GDH_{(red)} refers to the reduced state of GDH.

D-Glucose+GDH₍ₒₓ₎Gluconic acid+GDH_{(red)} T.1

Next, GDH_{(red)} is regenerated back to its active oxidized state by ferricyanide (i.e. oxidized mediator or Fe(CN)₆³⁻) as shown in chemical transformation T.2 below. In the process of regenerating GDH₍ₒₓ₎, ferrocyanide (i.e. reduced mediator or Fe(CN)₆⁴⁻) is generated from the reaction as shown in T.2:

GDH_{(red)}+2Fe(CN)₆³⁻GDH₍ₒₓ₎+2Fe(CN)₆⁴⁻ T.2

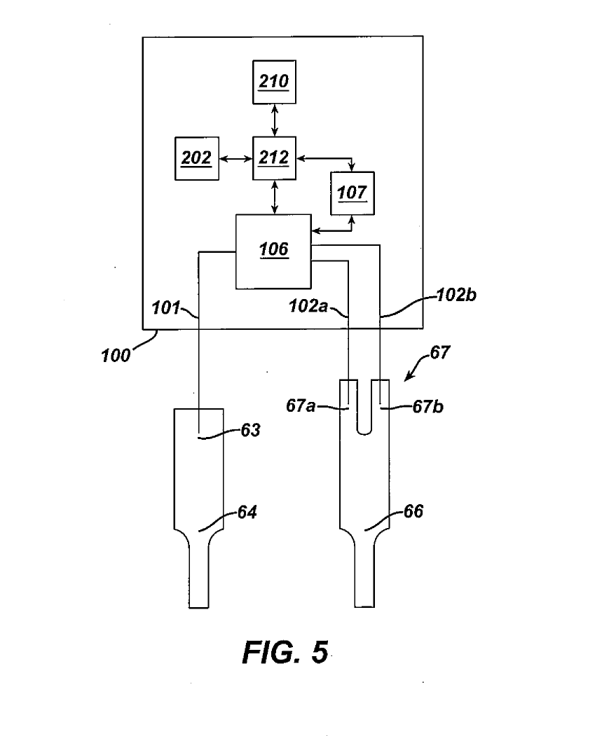

FIG. 5 provides a simplified schematic showing a test meter 100 interfacing with a first contact pad 67a, 67b and a second contact pad 63. The second contact pad 63 may be used to establish an electrical connection to the test meter through a U-shaped notch 65, as illustrated in FIG. 2. In one embodiment, the test meter 100 may include a second electrode connector 101, and a first electrode connectors (102a, 102b), a test voltage unit 106, a current measurement unit 107, a processor 212, a memory unit 210, and a visual display 202, as shown in FIG. 5. The first contact pad 67 may include two prongs denoted as 67a and 67b. In one exemplary embodiment, the first electrode connectors 102a and 102b separately connect to prongs 67a and 67b, respectively. The second electrode connector 101 may connect to second contact pad 63. The test meter 100 may measure the resistance or electrical continuity between the prongs 67a and 67b to determine whether the test strip 62 is electrically connected to the test meter 10. The electrodes 64 and 66 here can be utilized to detect physical characteristics of the sample using alternating signals. Alternatively, separate additional electrodes can be provided in the test chamber to allow for detection of the physical characteristics of the sample using alternating signals.

Meter 10 may include electronic circuitry that can be used to apply a plurality of voltages to the test strip 62 and to measure a current transient output resulting from an electrochemical reaction in a test chamber of the test strip 62. Meter 10 also may include a signal processor with a set of instructions for the method of determining an analyte concentration in a fluid sample as disclosed herein.

As is known, the user inserts the test strip into a strip port connector of the test meter to connect at least two electrodes of the test strip to a strip measurement circuit. This turns on the meter 100 and meter 100 may apply a test voltage or a current between the first contact pad 67 and the second contact pad 63. Once the test meter 100 recognizes that the strip 62 has been inserted from step 602, the test meter 100 initiates a fluid detection mode. The fluid detection mode causes test meter 100 to apply a constant current of about 1 microampere between the first electrode 66 and the second electrode 64. Because the test strip 62 is initially dry, the test meter 10 measures a relatively large voltage. When the fluid sample is deposited onto the test chamber, the sample bridges the gap between the first electrode 66 and the second electrode 64 and the test meter 100 will measure a decrease in measured voltage that is below a predetermined threshold causing test meter 10 to automatically initiate the glucose test by application of a first voltage potential E1.

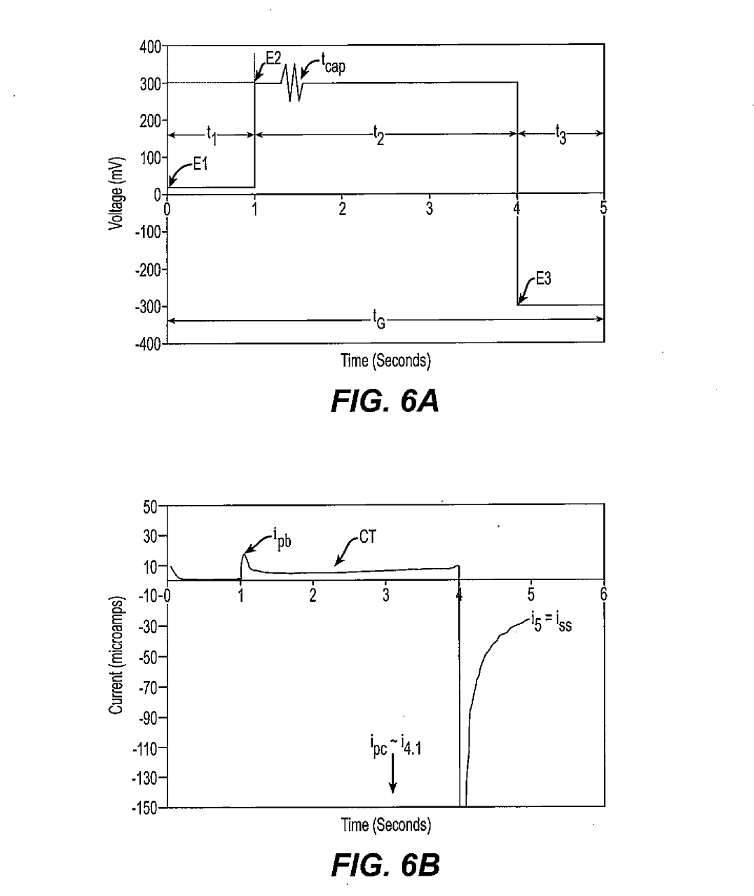

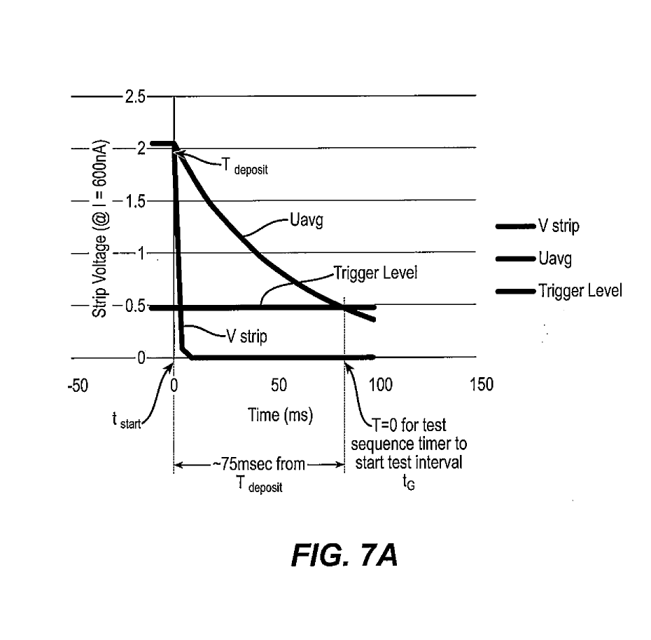

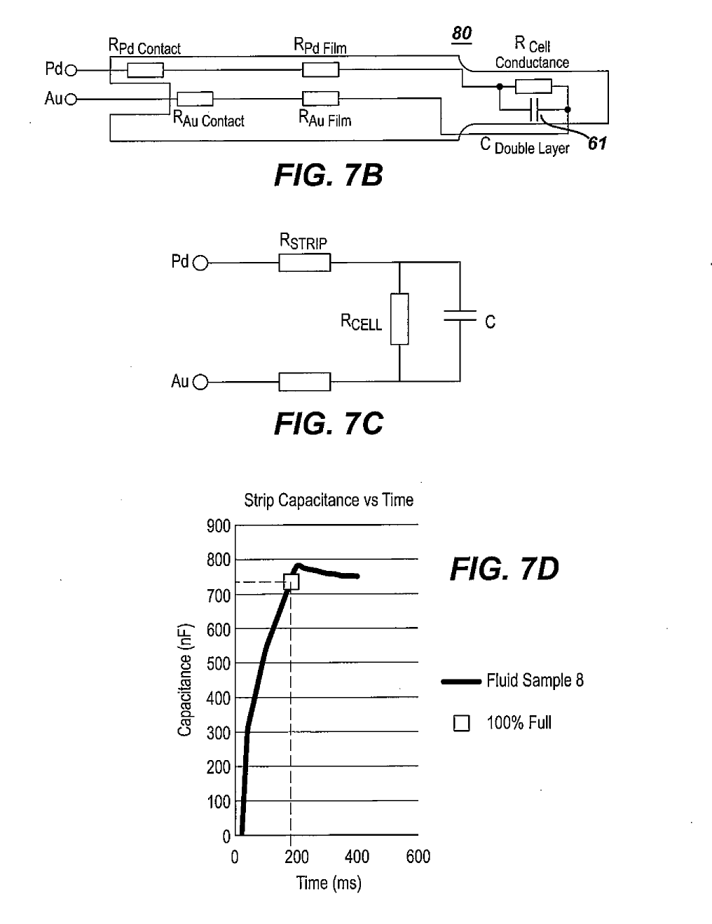

In FIG. 6A, the analyte in the sample is transformed from one form (e.g., glucose) into a different form (e.g., gluconic acid) due to an electrochemical reaction in the test chamber that starts with initiation of the test sequence at T=0 by a test sequence timer, which timer is set by a detection of strip fill (in FIG. 7A) and setting the potential at E1 for a first duration of t1. The system proceeds by switching the first voltage potential from E1 to a second voltage potential E2 different than the first voltage (FIG. 6A) for a second duration t2, then the system further changes the second voltage to a third voltage E3 different from the second voltage E2 (FIG. 6A) for a third duration t3.

FIG. 6A is an exemplary chart of a plurality of test voltages applied to the test strip 62 for prescribed intervals. The plurality of test voltages may include a first test voltage E1 for a first time interval t₁ that begins with the system setting a starting time (T=0) whenever a fill detection circuit has indicated that a sample has been applied. After t1, a second test voltage E2 for a second time interval t₂ is applied, and a third test voltage E3 is applied for a third time interval t₃. The third voltage E3 may be different in the magnitude of the electromotive force, in polarity, or combinations of both with respect to the second test voltage E2. In the preferred embodiments, E3 may be of the same magnitude as E2 but opposite in polarity. A glucose test time interval t_{G} represents an amount of time to perform the glucose test (but not necessarily all the calculations associated with the glucose test). Glucose test time interval t_{G} may range from about 1.1 seconds to about 5 seconds. Further, as illustrated in FIG. 6A, the second test voltage E2 may include a direct (DC) test voltage component and a superimposed alternating (AC), or alternatively oscillating, test voltage component. The superimposed alternating or oscillating test voltage component may be applied for a time interval indicated by t_{cap}. This superimposed alternating voltage is utilized to determine if the strip has sufficient volume of the fluid sample in which to conduct a test. Details of this technique to determine sufficient volume for electrochemical testing are shown and described in U.S. Pat. Nos. 7,195,704; 6,872,298, 6,856,125, 6,797,150, which documents are incorporated by reference as if fully set forth herein with a copy provided in the Appendix.

The plurality of test current values measured during any of the time intervals may be performed at a sampling frequency ranging from about 1 measurement per microsecond to about one measurement per 100 milliseconds and preferably at about every 10 to 50 milliseconds. While an embodiment using three test voltages in a serial manner is described, the glucose test may include different numbers of open-circuit and test voltages. For example, as an alternative embodiment, the glucose test could include an open-circuit for a first time interval, a second test voltage for a second time interval, and a third test voltage for a third time interval. It should be noted that the reference to “first,” “second,” and “third” are chosen for convenience and do not necessarily reflect the order in which the test voltages are applied. For instance, an embodiment may have a potential waveform where the third test voltage may be applied before the application of the first and second test voltage.

In this exemplary system, the process for the system may apply a first test voltage E1 (e.g., approximately 20 mV in FIG. 6A) between first electrode 66 and second electrode 64 for a first time interval t₁ (e.g., 1 second in FIG. 6A). The first time interval t₁ may range from about 0.1 seconds to about 3 seconds and preferably range from about 0.2 seconds to about 2 seconds, and most preferably range from about 0.3 seconds to about 1.1 seconds.

The first time interval t₁ may be sufficiently long so that the sample-receiving or test chamber 61 may fully fill with sample and also so that the reagent layer 72 may at least partially dissolve or solvate. In one aspect, the first test voltage E1 may be a value relatively close to the redox potential of the mediator so that a relatively small amount of a reduction or oxidation current is measured. FIG. 6B shows that a relatively small amount of current is observed during the first time interval t₁ compared to the second and third time intervals t₂ and t₃. For example, when using ferricyanide or ferrocyanide as the mediator, the first test voltage E1 in FIG. 6A may range from about 1 mV to about 100 mV, preferably range from about 5 mV to about 50 mV, and most preferably range from about 10 mV to about 30 mV. Although the applied voltages are given as positive values in the preferred embodiments, the same voltages in the negative domain could also be utilized to accomplish the intended purpose of the claimed invention.

Referring back to FIG. 6A, after applying the first test voltage E1, the test meter 10 applies a second test voltage E2 between first electrode 66 and second electrode 64 (e.g., approximately 300 mVolts in FIG. 6A), for a second time interval t₂ (e.g., about 3 seconds in FIG. 6A). The second test voltage E2 may be a value different than the first test voltage E1 and may be sufficiently negative of the mediator redox potential so that a limiting oxidation current is measured at the second electrode 64. For example, when using ferricyanide or ferrocyanide as the mediator, the second test voltage E2 may range from about zero mV to about 600 mV, preferably range from about 100 mV to about 600 mV, and more preferably is about 300 mV.

The second time interval t₂ should be sufficiently long so that the rate of generation of reduced mediator (e.g., ferrocyanide) may be monitored based on the magnitude of a limiting oxidation current. Reduced mediator is generated by enzymatic reactions with the reagent layer 72. During the second time interval t₂, a limiting amount of reduced mediator is oxidized at second electrode 64 and a non-limiting amount of oxidized mediator is reduced at first electrode 66 to form a concentration gradient between first electrode 66 and second electrode 64.

In an exemplary embodiment, the second time interval t₂ should also be sufficiently long so that a sufficient amount of ferricyanide may be diffused to the second electrode 64 or diffused from the reagent on the first electrode. A sufficient amount of ferricyanide is required at the second electrode 64 so that a limiting current may be measured for oxidizing ferrocyanide at the first electrode 66 during the third test voltage E3. The second time interval t₂ may be less than about 60 seconds, and preferably may range from about 1.1 seconds to about 10 seconds, and more preferably range from about 2 seconds to about 5 seconds. Likewise, the time interval indicated as t_{cap} in FIG. 6A may also last over a range of times, but in one exemplary embodiment it has a duration of about 20 milliseconds. In one exemplary embodiment, the superimposed alternating test voltage component is applied after about 0.3 seconds to about 0.4 seconds after the application of the second test voltage E2, and induces a sine wave having a frequency of about 109 Hz with an amplitude of about +/−50 mV.

FIG. 6B shows a relatively small peak i_{pb} after the beginning of the second time interval t₂ followed by a gradual increase of an absolute value of an oxidation current during the second time interval t₂. The small peak i_{pb} occurs due oxidation of endogenous or exogenous reducing agents (e.g., uric acid) after a transition from first voltage E1 to second voltage E2. Thereafter, there is a gradual absolute decrease in oxidation current after the small peak i_{pb} is caused by the generation of ferrocyanide by reagent layer 72, which then diffuses to second electrode 64.

After application of the second test voltage E2, the test meter 10 applies a third test voltage E3 between the first electrode 66 and the second electrode 64 (e.g., about −300 mVolts in FIG. 6A) for a third time interval t₃ (e.g., 1 second in FIG. 6A). The third test voltage E3 may be a value sufficiently positive of the mediator redox potential so that a limiting oxidation current is measured at the first electrode 66. For example, when using ferricyanide or ferrocyanide as the mediator, the third test voltage E3 may range from about zero mV to about −600 mV, preferably range from about −100 mV to about −600 mV, and more preferably is about −300 mV.

The third time interval t₃ may be sufficiently long to monitor the diffusion of reduced mediator (e.g., ferrocyanide) near the first electrode 66 based on the magnitude of the oxidation current. During the third time interval t₃, a limiting amount of reduced mediator is oxidized at first electrode 66 and a non-limiting amount of oxidized mediator is reduced at the second electrode 64. The third time interval t₃ may range from about 0.1 seconds to about 5 seconds and preferably range from about 0.3 seconds to about 3 seconds, and more preferably range from about 0.5 seconds to about 2 seconds.

FIG. 6B shows a relatively large peak i_{pc} at the beginning of the third time interval t₃ followed by a decrease to a steady-state current iₛₛ value. In one embodiment, the second test voltage E2 may have a first polarity and the third test voltage E3 may have a second polarity that is opposite to the first polarity. In another embodiment, the second test voltage E2 may be sufficiently negative of the mediator redox potential and the third test voltage E3 may be sufficiently positive of the mediator redox potential. The third test voltage E3 may be applied immediately after the second test voltage E2. However, one skilled in the art will appreciate that the magnitude and polarity of the second and third test voltages may be chosen depending on the manner in which analyte concentration is determined.

Referring to FIG. 6B, the system at step 612 also measure a second current output of the current transient from the electrodes after the changing from the second voltage to the third voltage and then the system proceeds by estimating a current that approximates a steady state current output of the current transient after the third voltage is maintained at the electrodes.

A determination of the glucose concentration from the current transient CT can be found in U.S. Pat. No. 7,749,371, patented Jul. 6, 2010, which was filed on 30 Sep., 2005 and entitled “Method and Apparatus for Rapid Electrochemical Analysis,” which is hereby incorporated by reference in its entirety into this application and attached hereto as part of the Appendix.

It has been discovered by applicant that an appropriate start time for a start of the test sequence (when a test sequence clock is set to T=0 after a sample has been applied) may not be appropriate due to the nature of the sample detector of the biosensor utilized herein. When the clock for timing the first, second and third intervals is not set at the appropriate time to start the test sequence, the time points at which the current transient CT are sampled in FIG. 6B in order to calculate the glucose concentration may not be at the appropriate sampling time points, thus possibly leading to an inaccurate or even wrong glucose result. It is believed that the reason for this is because the biosensor 62 does not utilize a separate sample detection electrode. Instead, the biosensor 62 attempts to drive a generally constant current of about 600 nanoamps between electrodes 63 and 67 while monitoring the voltage generated across these electrodes, shown here in FIG. 7A.

Referring to FIG. 7A, the system is able to determine when a sample is first deposited at T_{deposit} after tₛₜₐᵣₜ because any amount of a sample produces a low enough resistance such that the system can detect a voltage drop as soon as any amount of a sample is placed onto the electrodes at around time point T_{deposit}. An issue may arise when a volume of the sample initially deposited onto the chamber 61 is too slow to fill the test chamber 61. To ameliorate this, the system is designed to perform a rolling average (“U_{AVG}”) of the voltage detected between the two electrodes until the rolling average voltage U_{AVG} is at about 0.5 volt or lower. This allows for a time delay to be built into the system when the system sets the sequence test timing clock at T=0 in order to start the timing intervals t₁, t₂, and t₃ of FIG. 6A. However, it has been discovered by applicant that no matter how quickly or slowly fluid sample is filing the test chamber 61, the delay time is generally about 75 milliseconds. Where the sample has high viscosity (such as in high percent hematocrit blood samples) such that 75 milliseconds may not be enough time for the sample to flow into the chamber. When the chamber is insufficiently filled, the electrochemical reaction may not proceed as intended when the test sequence clock is set to zero for the timing intervals t₁, t₂, and t₃, leading to inaccurate results. On the other hand, when the sample has low internal friction or low viscosity (such as in low percent hematocrits blood samples) leading to a sample that may flow into the test chamber very quickly such that the electrochemical reaction could have proceeded for a certain amount of time even before the test sequence clock has been set to zero. Consequently, for low or high viscosity samples, the test sequence may have started before the sample has flow into the chamber or the test sequence (with the test sequence clock set to zero) may not have started even though the test chamber has been fully filled. Thus, setting a test sequence start time at the appropriate moment is believed to further improve the accuracy and precision of the biosensor.

To allow the system to detect that the test chamber 61 has stopped filling before initiating the test sequence time clock, applicant has implemented a novel technique using capacitance detection of the sample filling process. In this technique, capacitance of the sample flowing into the test chamber 61 is used to determine when the test chamber has stopped filling with sample fluid. At the same time, capacitance can be used to estimate the volume of the sample size to allow for resolution of another potential issue once the test sequence has started.

However, before describing an overview of the technique, it is worthwhile to provide a brief description of the capacitance detection for the biosensors described here. Referring to FIG. 7B, the biosensor test strip 80 and test cell 61 with the electrode layers can be represented as a series of resistors (R_{Pdcontact}, R_{PdFilm}, R_{AuContact}; and R_{AuFilm} in schematic form in FIG. 7B), and the test cell 61 can be represented as a parallel resistor-capacitor circuit having R_{Cell Conductance} and C_{DoubleLayer} in FIG. 7B. The resistance of the strip 80 and the parallel resistor-capacitor of test cell 61 can be modeled of FIG. 7C in the form of a circuit having a series resistor R_{STRIP} for the biosensor's gold and palladium layers and a parallel resistor R_{Cell} and capacitor C circuit for the test cell test cell 61, shown here as FIG. 7C. In this R-C circuit of FIG. 7C, the system can drive an alternating voltage with frequency f and root-mean-squared (“RMS”) amplitude V, and measure total current i_{T} as RMS value and phase angle Φ, capacitance C of the test cell 61 can be derived with the appropriate offset to account for the strip resistivity R_{STRIP} and any phase shifting caused by the measurement circuit. In particular, the capacitance C can be determined with the following Equation 1:

C=|(i_{T} sin Φ)|/2πfV Eq. 1
Where
i_{T} represents the total current;
Φ represents the phase angle;
f represents the frequency of the applied signal;
V represents the magnitude of the applied signal.

The magnitude of the applied signal is about 50 millivolts and the frequency is about 109 Hertz. Additional details of the capacitance measurement technique can be gleaned from copending US Patent Application Publications 20110208435; 20110301861; and 20110309846, all of which are hereby incorporated by reference into this application as if fully set forth herein.

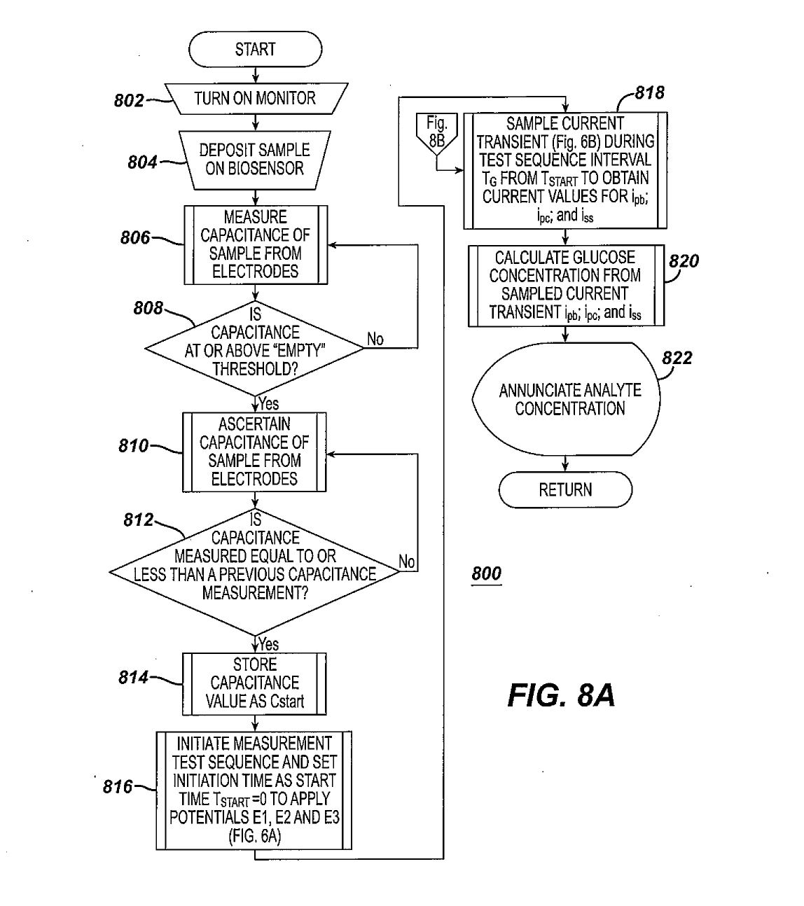

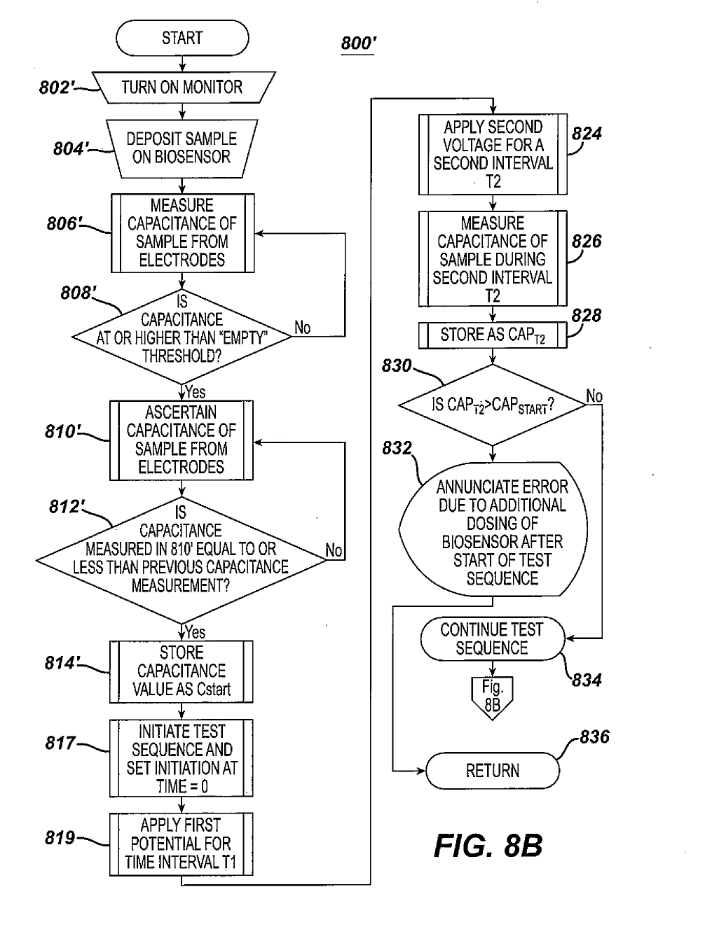

Referring to FIG. 7D, applicant has discovered that capacitance of the sample can be used to determine when a test chamber has stopped filling with a fluid sample such that the test sequence can be started at time T=0. Specifically, in FIG. 7D, a high-speed digital camera was used to determine when a test chamber has stopped filling or actually been filled as compared to a capacitance measurement of the biosensor during a filling phase. From FIG. 7D, it can be seen that when a suitable sample (e.g., blood or control solution, which in this case is the most viscous or highest viscosity control solution available for this strip) is deposited on the test chamber, the measured capacitance rose until it abruptly changed its rate and direction (or inflection) at approximately 200 milliseconds after the start of a strip fill. The inflection point of the capacitance matches relatively closely to the actual filling as observed with the digital camera. As such, it is believed that the inflection point of the capacitance measurement can be used to reliably indicate a point at which the test strip has stopped filling with fluid sample in order to start a test sequence with the test sequence clock T set to zero. Consequently, applicant has utilized this inflective behavior in capacitance of the test strip to provide for the new techniques shown and described in relation to FIGS. 8A and 8B.

FIG. 8A illustrates logic 800 to allow for a determination of an analyte concentration in a sample using this novel test start time setting technique. Step 802 begins with the meter or monitor being turned on, which for certain meters can be by insertion of a biosensor or activation of a power switch. At step 804, a sample can be deposited onto the electrodes in the test chamber 61 and a capacitance of the sample can be measured at step 806. At step 808, an evaluation is made as to whether the measured capacitance from the measuring step is above a first threshold. In the event the measured capacitance is not above the first threshold, i.e., step 808 returns a “NO” then, repeating the measuring step 806 again. On the other hand, if the measured capacitance is above the first threshold, i.e., step 808 returns a “YES”, ascertainment is made of another capacitance of the fluid sample in step 810. At step 812, another evaluation is made as to whether the ascertained capacitance from step 810 is substantially the same or less than a previous measurement of the capacitance. In the event the ascertained capacitance is not less than previous measurement of capacitance, i.e., step 812 returns a “NO”: then the ascertaining step 810 is performed again otherwise if the ascertained capacitance is substantially the same or less than a previous measurement of the capacitance of the sample (i.e., step 812 returns a “YES”) then the ascertained capacitance is stored at step 814 as a first capacitance value “Cₛₜₐᵣₜ”. At the same time or shortly thereafter, the system can also set a test sequence time clock to zero to allow the system define a referential start time of a glucose measurement test sequence interval T_{G} in FIGS. 6A and 6B.

To recap, the system described herein, including the microcontroller 106 is able to determine (via its connection to the electrodes) when the fluid sample has stopped filling the test chamber 61 (due to detection of an inflection of the change in capacitance of the sample by steps 806-812) to define a start time T=0 of an analyte test sequence. For clarity, it should be noted that this capacitance measurement is to primarily determine if the fluid sample has stopped entering the test chamber and secondarily to determine whether a sufficient volume has entered the test chamber.

Referring to FIG. 8A, step 816 applies a series of electrical potentials to the at least two electrodes during the measurement sequence interval starting from a zero time point of the test sequence time clock in FIG. 6A. Referring to step 818, the logic also measures or samples a current output transient CT from the at least two electrodes during the measurement test sequence interval to obtain a series of current output transients (shown here in FIG. 6B). At step 820, an analyte concentration, e.g., glucose concentration, can be calculated from the current transient outputs with Equation 2-4:

$$\begin{matrix}G = {( \frac{\vert {i}_{r} \vert}{\vert {i}_{l} \vert} )}^{p} ( a \vert {i}_{2 CORR} \vert - zgr ) ; \\ where \text{:} \\ {i}_{r} = {\sum }_{t = 4.4}^{t = 5} i ( t ) ; \\ {i}_{l} = {\sum }_{t = 1.4}^{t = 4} i ( t ) ; & Eq . 2 \\ {i}_{2 ( Corr )} = ( \frac{\vert {i}_{pc} \vert + b \vert {i}_{ss} \vert - c \vert {i}_{pb} \vert}{\vert {i}_{pc} \vert + b \vert {i}_{ss} \vert} ) {i}_{r} ; & Eq . 3\end{matrix}$$

and
Where a, b, c, p, and zgr are glucose calculation coefficients.
In one embodiment, p˜0.523; a˜0.14; zgr˜2.

In this exemplary embodiment, i_{pb} is the current measured at approximately 1.1 second; i_{pc} is current measured from the electrodes of the strip 62 at approximately 4.1 seconds; iₛₛ is the current measured at approximately 5 seconds. For ease of notation, Eq. 3 for this known glucose concentration calculation, can be represented in the following notation as Equation 4:

$${i}_{2 ( Corr )} = ( \frac{\vert {i}_{4.1} \vert + b \vert {i}_{5} \vert - c \vert {i}_{1.1} \vert}{\vert {i}_{4.1} \vert + b \vert {i}_{5} \vert} ) {i}_{r} \qquad Eq . 4$$

Although the applied voltages are given as positive values in the preferred embodiments, the same voltages in the negative domain could also be utilized to accomplish the intended purpose of the claimed invention.

Referring back to FIG. 8A, once the glucose concentration has been calculated, the system may annunciate the result at step 822. As used here, the root term “annunciate” and variations on the root term indicate that an announcement may be provided via text, audio, visual or a combination of all modes of communication to a user.

Applicant has further discovered that there another benefit to the determination of the fill-capacitance C_{START} obtained in step 814 to detect instances of the user adding more samples to the test strip even after the initial dosing of the test strip, also known as a “double dosing” of the test strip, which could cause an inaccurate result once the test sequence has started. To detect a double or multiple dosings of the test chamber 61, applicant has devised another technique, shown and described here in relation to FIG. 8B with logic 800′.

In FIG. 8B, steps with reference numerals and asterisk have the same function as the corresponding reference numerals described in FIG. 8A and therefore will not be described again for brevity. As such, applicant will describe step 817 in which the test sequence clock T is reset to zero and the test sequence is started at this point in time. As shown in FIG. 6A, a first potential E1 is applied for a first time interval t₁ (as measured from T=0 when the test sequence clock is set to zero at step 816 of FIG. 8A or step 817). After the first time interval t₁, a second potential E2 is applied for a second time interval t₂. During this time interval t₂ (at for example about 1.3 seconds in FIG. 6A), through the use of an alternating signal (AC) at a predetermined frequency (˜109 Hz), capacitance of the test chamber is determined in step 826 and stored as CAP_{T2} in step 828. Applicant notes that this second capacitance measurement, unlike the first capacitance measurement, is primarily intended to determine whether there is sufficient volume of the sample. Details of this measurement are provided in U.S. Pat. No. 6,872,298, which is hereby incorporated as if fully set forth herein.

At step 830, an evaluation is made as to whether the capacitance at the second time interval (or CAP_{T2}) is greater than the capacitance measured during the initial fill phase (or C_{START}) before the first time interval t₁. If true, the logic moves to step 832 in which an error is annunciated in that there has been multiple dosings of the test strip after the initial fill. On the other hand, if the evaluation step 830 returns a “NO” the logic moves to step 834 which allows for the test sequence to continue by moving (in FIG. 8A) to steps 818, 820, and 822 as described earlier.

Applicants note that this new technique is applicable to any analyte measurement and is not limited to glucose measurement of blood. For example, one skilled in the art, with appropriate modification to the threshold values and measurements of the capacitance, will be able to apply this in the same spirit and intent as described herein for other analyte measurements such as uric acid, ketone, cholesterol, creatine and the like. Accordingly, while the invention has been described in terms of particular variations and illustrative figures, those of ordinary skill in the art will recognize that the invention is not limited to the variations or figures described. In addition, where methods and steps described above indicate certain events occurring in certain order, those of ordinary skill in the art will recognize that the ordering of certain steps may be modified and that such modifications are in accordance with the variations of the invention. Additionally, certain of the steps may be performed concurrently in a parallel process when possible, as well as performed sequentially as described above. Therefore, to the extent there are variations of the invention, which are within the spirit of the disclosure or equivalent to the inventions found in the claims, it is the intent that this patent will cover those variations as well.

1. A method of determining an analyte concentration from a fluid sample with a test strip having at least two electrodes and an analyte monitor having a microprocessor coupled to a test strip port that connects via corresponding connectors to the at least two electrodes of the test strip, the method comprising the steps of:
depositing a fluid sample onto the at least two electrodes;
measuring a capacitance of the fluid sample with the at least two electrodes;
evaluating whether the measured capacitance from the measuring step is above a first threshold;
in the event the measured capacitance is not above the first threshold, repeating the measuring step again; otherwise, if the measured capacitance is above the first threshold, ascertaining a capacitance of the fluid sample;
evaluating whether or not the ascertained capacitance from the ascertaining step is less than or substantially the same as a previous measurement of the capacitance;
in the event the ascertained capacitance is not less than previous measurement of capacitance, performing the ascertaining again otherwise if the ascertained capacitance is substantially the same or less than a previous measurement of the capacitance of the sample then storing the ascertained capacitance as a first capacitance value and setting a test sequence time clock to zero immediately after the storing step to define a start time of an analyte measurement test sequence interval; and
applying a series of electrical potentials to the at least two electrodes during the measurement sequence interval starting from a zero time point of the test sequence time clock;
sampling a current output transient from the at least two electrodes during the measurement test sequence interval to obtain a series of current output transients; and
calculating an analyte concentration from the series of current output transients of the sampling step.

2. A method of determining an analyte concentration from a fluid sample with a test strip and an analyte monitor having a microprocessor coupled to a test strip port adapted to receive corresponding connectors connected to at least two electrodes of the test strip, the method comprising the steps of:
depositing a fluid sample onto the at least two electrodes;
measuring a capacitance of the fluid sample with the at least two electrodes;
evaluating whether the measured capacitance from the measuring step is above a first threshold;
in the event the measured capacitance is not above the first threshold, repeating the measuring step again otherwise if the measured capacitance is above the first threshold, ascertaining a capacitance of the fluid sample;
evaluating whether the ascertained capacitance from the ascertaining step is substantially the same or less than a previous measurement of the capacitance;
in the event the ascertained capacitance is not less than previous measurement of capacitance, performing the ascertaining again otherwise if the ascertained capacitance is substantially the same or less than a previous measurement of the capacitance of the sample then storing the ascertained capacitance as a first capacitance value and setting a test sequence time clock to zero immediately after the storing step to define a start time of an analyte measurement test sequence interval; and
applying a series of electrical potentials to the at least two electrodes during the measurement sequence interval starting from a zero time point of the test sequence time clock;
measuring a capacitance during the test sequence interval after the setting of the time clock to zero;
storing the measured capacitance during the test sequence interval as a second capacitance;
evaluating whether the second capacitance is greater in magnitude than the first capacitance;
in the event the evaluating indicates that the second capacitance is greater than the first capacitance, annunciating an error due to additional fluid samples being added after the start of the test sequence time clock.

3. A method for determining a start time of an analyte measurement test sequence for a fluid sample with a test strip and an analyte monitor having a microprocessor coupled to a test strip port adapted to receive corresponding connectors connected to at least two electrodes of the test strip, the method comprising the steps of:
depositing a fluid sample onto the at least two electrodes;
measuring a capacitance of the fluid sample with the at least two electrodes;
evaluating whether the measured capacitance from the measuring step is above a first threshold;
in the event the measured capacitance is not above the first threshold, repeating the measuring step again otherwise if the measured capacitance is above the first threshold, ascertaining a capacitance of the fluid sample;
evaluating whether the ascertained capacitance from the ascertaining step is substantially the same or less than a previous measurement of the capacitance;
in the event the ascertained capacitance is not less than previous measurement of capacitance, performing the ascertaining again otherwise if the ascertained capacitance is substantially the same or less than a previous measurement of the capacitance of the sample then storing the ascertained capacitance as a first capacitance value and setting a test sequence time clock to zero immediately after the storing step to define a start time of an analyte measurement test sequence interval.

4. The method of any one of claims 1-3, in which the measuring comprises applying an alternating signal at a predetermined frequency to the at least two electrodes and measuring a phase signal from the at least two electrodes.

5. The method of claim 4, in which the first threshold is about 10 nanofarads.

6. The method of claim 1, in which the analyte comprises glucose.

7. An analyte measurement system comprising:
an analyte test strip including:
a substrate having a reagent disposed thereon;
at least two electrodes proximate the reagent in test chamber;
an analyte meter including:
a strip port connector disposed to connect to the two electrodes;
a power supply; and
a microcontroller electrically coupled to the strip port connector and the power supply so that, when the test strip is inserted into the strip port connector and a fluid sample is deposited in the test chamber, the microcontroller determines when the fluid sample has stopped filling the test chamber to define a start time of an analyte test sequence.

8. The system of claim 7, in which the microcontroller is configured to start a test timing clock when the microcontroller has determined that the sample has stopped filling the test chamber, apply a series of electrical potentials to the at least two electrodes for respective time intervals, sample a current output transient over the same respective time intervals, and calculate an analyte concentration from the sampled current output transient.

9. The system of claim 7, in which the analyte comprises glucose.
